(19) United States
(12) Patent Application Publication
(10) Pub. No.: US 2026/0240138 A1
(43) Pub. Date: Aug. 20, 2026

(54) THE CATCHING BLADE

(71) Applicant: FLIXY INVENTION AB, Alingsås (SE)

(72) Inventor: Hans Gunnar ANDERSSON, Alingsås (SE)

(73) Assignee: FLIXY INVENTION AB, Alingsås (SE)

(21) Appl. No.: 19/521,587

(22) PCT Filed: Jul. 24, 2024
(86) PCT No.: PCT/SE2024/000004

§ 371 Date: Mar. 20, 2026

(30) Foreign Application Priority Data
Jul. 31, 2023 (SE) 2300068-0

(51) Int. Cl. A01M 1/16

(52) U.S. Cl. CPC A01M 1/16

(57) ABSTRACT

Provided is a catch blade, with a surface comprising closely spaced elevations extending from the entire surface, with each elevation having either terminating tip or ridge formations, whose upper surface is smooth and with low friction. All of the remaining surface of the catch blade is coated with a tacky soft adhesive. The tips and ridges create a distance above the portions of the surface with the tacky soft adhesive, such that the tacky soft adhesive does not come into contact with an underlying surface contacted by the catch blade during use. In this way, the catch blade can freely be brought into contact with an underlying surface without sticking to the underlying surface, while at the same time exposing the surface of the catch blade with the tacky soft adhesive to insects, which stick to the tacky soft adhesive upon contact.

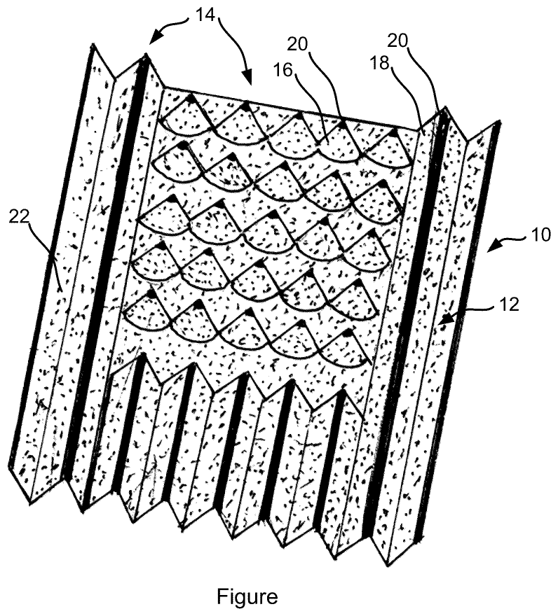

### CROSS-REFERENCE TO RELATED APPLICATIONS

This application is a national stage application (filed under 35 U.S.C. § 371) of PCT/SE2024/000004, filed Jul. 24, 2024, of the same title, which in turn claims the benefit of priority to Swedish Patent App. No. 2300068-0, filed on Jul. 31, 2023; the contents of each of which are hereby incorporated herein by reference.

### TECHNICAL FIELD

The present disclosure relates to a blade for capture and disposal of insects.

### BACKGROUND

Various insect capture and disposal devices are known. Some involve a strip with a surface coating of soft adhesive that is placed in various places for capturing insects. The strips are disposed of after use. “Fly strike” devices are known where impact energy of the devices mash the insects. Further, electric trapping devices are known where high voltage kills the insects on contact.

### SUMMARY OF THE INVENTION

Provided is a material in the form of a catch blade comprising a surface used to capture insects. The surface of the blade comprises a plurality of elevations in close proximity to one another, wherein each of the elevations terminates at an uppermost portion, in either a pointed shape or a ridge-like shape having an uppermost peak portion. Each uppermost peak portion is either provided with a smooth glossy coating or is uncoated. The remainder of the surface is provided with a coating of a tacky soft adhesive that is non-air drying. In some embodiments, the elevations are located across the entire surface.

The described catch blade is capable of being maneuvered to confront and contact different surfaces materials without sticking thereto. For this purpose, the points and/or ridges of the elevations on the surface of the catch blade are non-adhesive and create a distance between the elevation and the remainder of the surface comprising the soft adhesive, such that when the catch blade comes into contact with the underlying surface being struck by the catch blade, it does not adhere thereto. Further, the soft adhesive coating on the remaining portions of the surface is exposed, so that insects can stick thereto.

### BRIEF DESCRIPTION OF THE DRAWINGS

Figure describes a surface of a catch blade according to the present invention.

### DETAILED DESCRIPTION

Disclosed is a material formed as a catch blade (10) with a structural shape and a surface (12) having a profile comprising elevations (14) spaced closely adjacent to one another over the entire, or substantially the entire surface (12) of the blade (10).

Each elevation comprises an uppermost portion extending from the surface that terminates in either a pointed shape (16) or a ridge-like shape (18) having an uppermost peak portion (20). The surface could have both pointed shape (16) and ridge-like shape (18) elevations. The uppermost peak portion of each elevation is either coated with a glossy surface coating or left bare and uncoated without soft adhesive. The remaining surface of the blade that does not form the uppermost peak portions is coated with a sticky soft adhesive (22), that does not dry when exposed to air. The blade can be fitted with a shaft, not shown, to provide increased reach and to enable manual operation of the catch blade.

In use, the uppermost peak portion of each elevation prevents the catch blade from adhering to any surface contacted by the catch blade, while the portions of the catch blade surface coated with the tacky soft adhesive are capable of adhering to the target insect.

Thus, in the case of actively capturing insects, the catch blade allows unwanted insects to be captured and disposed of without requiring force to capture and attach the insects. The tacky, soft adhesive-coated surface of the catch blade attaches insects upon contact, while the blade can be maneuvered without the adhesive sticking to surrounding surfaces or materials. This enables users, including those with reduced muscle strength or limited mobility, to actively capture unwanted insects with ease.

1. A material in the form of a blade comprising a surface used to capture insects, said surface comprises a plurality of elevations in close proximity to one another, wherein each of said elevations terminates, at an uppermost portion, in either a pointed shape or a ridge-like shape having an uppermost peak portion, wherein each uppermost peak portion is either provided with a smooth glossy coating or is uncoated, and wherein a remainder of the surface is provided with a coating of a tacky soft adhesive that is non-air drying.
